(19) United States
(12) Patent Application Publication
(10) Pub. No.: US 2005/0216715 A1
(43) Pub. Date: Sep. 29, 2005

(54) System and method for flexible option ROM booting

(76) Inventors: David L. Matheny, Cedar Park, TX (US); Eric L. Blair, Austin, TX (US)

Correspondence Address: BUCKLEY, MASCHOFF, TALWALKAR LLC, 5 ELM STREET, NEW CANAAN, CT, 06840, US

(21) Appl. No.: 10/811,533

(22) Filed: Mar. 29, 2004

(51) Int. Cl. G06F 9/00

(52) U.S. Cl. 713/1

(57) ABSTRACT

A method includes receiving input from a user and, in response to the input, selecting one of a BCV (boot connection vector) pointer and a BEV (bootstrap entry vector) pointer to have a non-null value.

### BACKGROUND

Upon being powered up, or in response to a reset condition, conventional microcomputers undergo an initialization process known as “booting”. The boot process generally involves initializing peripheral devices such as disk drives, and loading an operating system into main memory (random access memory or “RAM”) so that program execution may be performed in accordance with the user's wishes. Other initialization steps such as self-testing may also be performed. Certain conventional boot processes are described in an article by R. Wade et al., entitled “The PC-AT Boot Process and Option ROMs” published in the September/October, 1999, issue of Intel Developer UPDATE Magazine. Additional details of some standard boot practices are found in the “BIOS Boot Specification”, Version 1.01, issued Jan. 11, 1996 by Compaq Computer Corporation, Phoenix Technologies Ltd., and Intel Corporation (the latter company being the assignee hereof). As is well-known to those who are skilled in the art, “BIOS” refers to the Basic Input/Output System which controls the microcomputer during at least the initial phases of the boot process.

The source or sources of the operating system software that is loaded during the boot process may be one or more of a number of different devices. For example, these devices may be one or more local disks (hard disk drive(s) and/or floppy disk drive(s)), a ROM (read only memory), a PROM (programmable read only memory), a LAN (local area network) server. It may also be desirable to boot from one or more remote disks (e.g., included in a remote system or systems or in a dedicated storage unit).

Devices from which booting is to be performed and/or the order in which devices are booted from may be controlled by data in one or more option ROMs or similar devices that are part of the microcomputer system or may be added to the microcomputer system from time to time. According to the above-referenced BIOS Boot Specification, option ROMs and the like are categorized as either BCV (Boot Connection Vector) devices or BEV (Bootstrap Entry Vector) devices.

BCV devices are able to directly hook into the microcomputer system's disk access mechanism to provide access to a local disk. A SCSI (Small Computer System Interface) disk controller is an example of a BCV device. In some microcomputer systems, an int 13h mechanism is used to provide BIOS disk access. Thus, when a BCV device provides an int 13h handler in such systems, a locally accessible disk drive is added to the system.

BEV devices are able to boot the system but do not install local disk handler routines. A network interface controller (NIC) with Pre-boot Execution Environment (PXE) or Remote Program Load (RPL) installed is an example of a BEV device. As is familiar to those who are skilled in the art, PXE typically causes booting from a ROM or PROM, whereas RPL typically causes the microcomputer system to boot from a LAN server. BEV devices are able to copy a bootable image into main system memory and then to execute the copied bootable image. BEV devices make it possible for the system to boot from sources other than disks.

The above-mentioned BIOS Boot Specification (BBS) provides that a device may be either a BCV device or a BEV device, but not both. More specifically, the BBS provides that a device cannot have both a non-null BCV and a non-null BEV. In other words, at least one of the BCV and the BEV must be null. With the advent of iSCSI (Internet SCSI) booting, a problem arises from this requirement of the BBS that BCV and BEV devices are mutually exclusive.

iSCSI booting works by installing remote disks into the local int 13h interface so that the remote disks can be accessed as if they were local. This requires that the iSCSI boot be installed as a BCV device. However, it may be desired that the iSCSI boot reside in the option ROM of an NIC together with PXE and RPL functionality, which require a non-null BEV pointer. Thus it may be desirable for a single device such as the option ROM of an NIC to function as both a BCV device and a BEV device notwithstanding that the BBS declares such a dual status to be impermissible.

### BRIEF DESCRIPTION OF THE DRAWINGS

FIG. 1 is block diagram of a computer system according to some embodiments.

FIGS. 2A and 2B together from a flow chart that illustrates a process performed in accordance with some embodiments.

FIGS. 3 and 4 are example screen displays provided as part of a flash memory configuration process that may be part of the process of FIGS. 2A and 2B.

### DETAILED DESCRIPTION

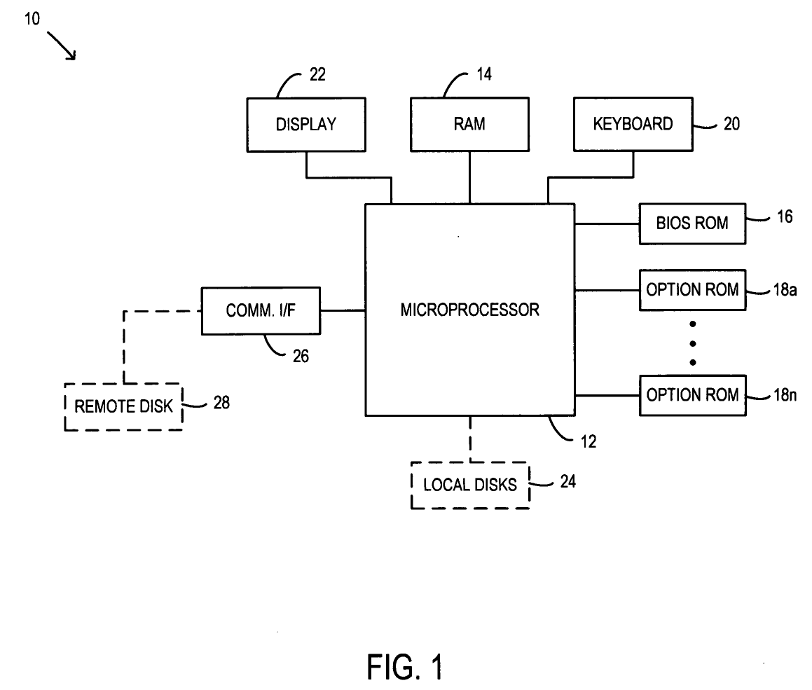

FIG. 1 is a block diagram of a computer system 10 according to some embodiments. In its hardware aspects, the computer system 10 may, but need not, be constituted entirely of conventional components.

The computer system 10 includes a microprocessor 12 which is coupled to various memory devices including main memory (random access memory or “RAM”) 14, a BIOS ROM (read only memory) 16 and option ROMs 18a-18n. Although elements 16 and 18a-18n are referred to as “ROMs” in accordance with commonly used nomenclature, in fact these devices may be flash memories which are not strictly “read only” but rather can also be written to by the microprocessor 12. The memory devices may store one or more programs to control the microprocessor 12 to operate in a desired manner, including a process in accordance with some embodiments as described below.

The computer system 10 also includes one or more input/output devices coupled to the microprocessor 12, such as a keyboard 20 to allow a user to provide input to the computer system 10 and a display device 22 (e.g., a CRT monitor or a flat panel display) that is controlled by the microprocessor to provide output to the user.

There may also be included in the computer system 10 one or more local disk drive devices 24 (shown in phantom), which may include one or more hard drives and/or one or more floppy disk drives. The local disks 24 are coupled to the microprocessor 12.

In addition, the computer system 10 may include a communication interface 26 which is coupled to the microprocessor 12. The microprocessor 12 may be in communication with one or more remote disk drives 28 (shown in phantom) via the communication interface 26. The remote drive 28 may be, for example, a component of a remote computer system, or a dedicated storage unit.

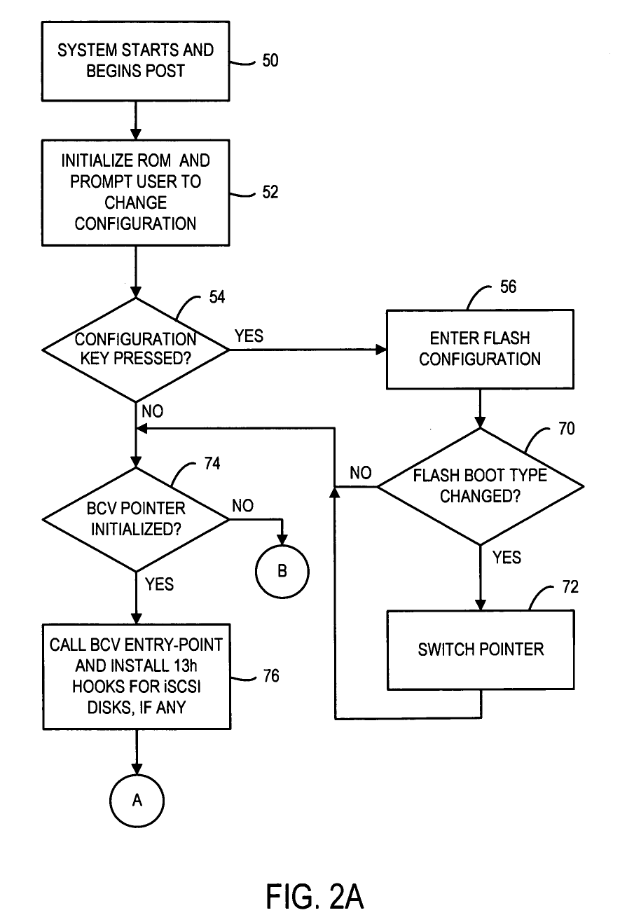

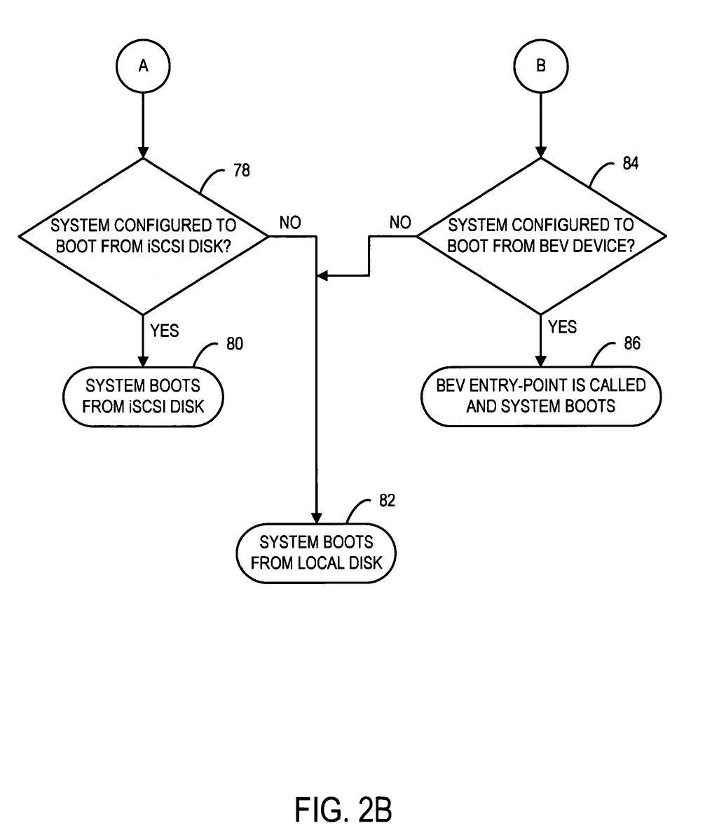

It may be assumed that one of the option ROMs 18a-18n (e.g., an option ROM of an NIC) contains boot code for iSCSI booting and also for one or more of PXE and RPL. A process provided according to some embodiments, and described below in connection with FIGS. 2A and 2B, allows these boot images to co-exist on a single device, notwithstanding the BBS mandate that a device cannot have both BCV and BEV pointers non-null. For this purpose, the process of FIGS. 2A and 2B may include a configuration utility that is for example either flash-based (e.g., in the BIOS ROM 16) or external to allow a user to select a desired boot option and to set the BCV and BEV pointer values accordingly.

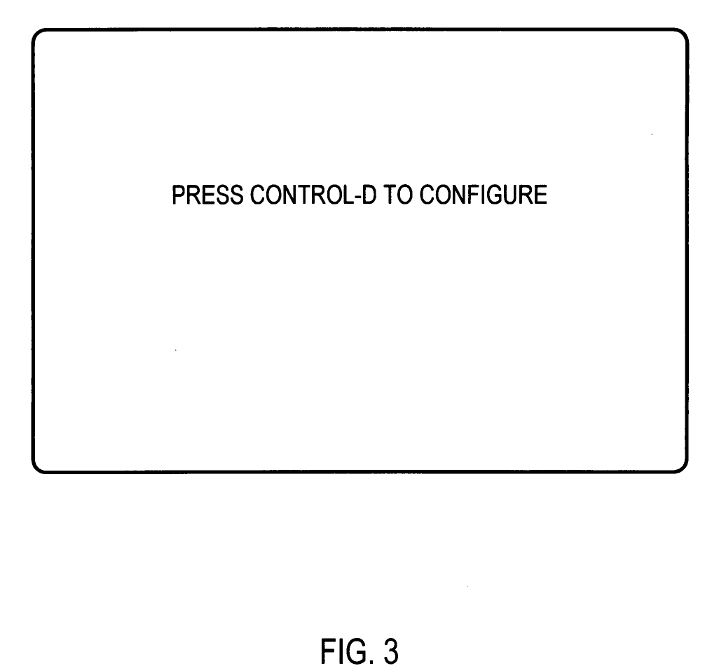

At 50 in FIG. 2A, the system powers up (or a reset condition is entered) and a power-on self test (POST) routine is performed. Then, at 52, the option ROM which contains both iSCSI and PXE and/or RPL is initialized and the user is prompted to indicate as to whether the user wishes to change the previously established boot process. In particular, the microprocessor 12 may control the display device 22 to display a screen display like that shown in FIG. 3. That is, the user may be prompted to press a certain key or combination of keys on the keyboard 20 to indicate that the user wishes to enter a configuration process to change the previously established boot process.

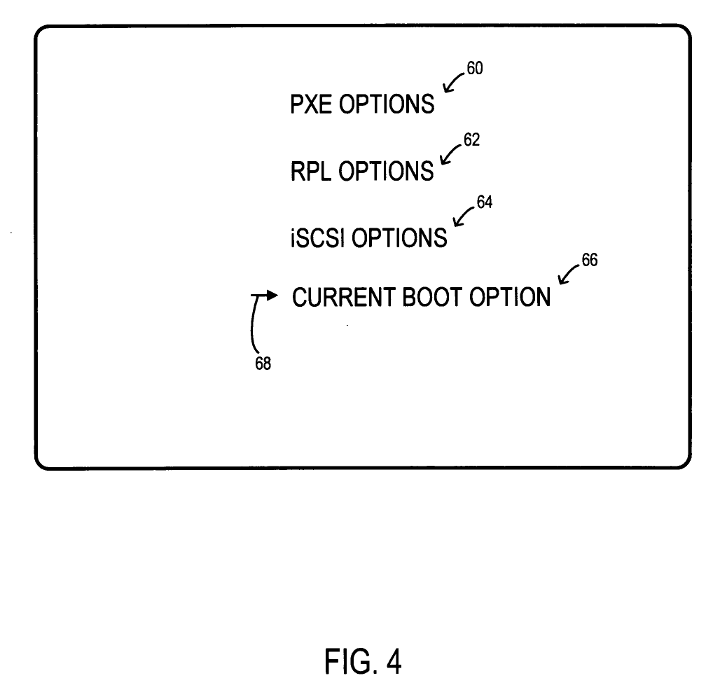

Indicated at 54 in FIG. 2A is a determination as to whether the user pressed the key or key combination indicated in the screen display of FIG. 3 within a predetermined period of time. If so, the system enters a flash configuration mode, as indicated at 56. As part of the flash configuration mode, one or more screen displays may be presented to the user via the display device 22 to present boot options to the user. An example of such a screen display is presented as FIG. 4. It will be noted that the screen display of FIG. 4 presents options 60 (“PXE options”), 62 (“RPL options”), 64 (“iSCSI options”) and 66 (“current boot option”). Also included in the screen display of FIG. 4 is a cursor 68, shown pointing to option 66. In some embodiments, the user may be permitted to reposition the cursor 68 among the options 60-66 by using, e.g., arrow keys on the keyboard 20. The user may be permitted to select the option to which the cursor 68 currently points by pressing an enter key on the keyboard 20. Accordingly, the system can receive input from the user concerning a boot option selected by the user. In some embodiments, if the user selects one of the options 60-64, a further screen display (not shown) may be presented to the user as part of the flash configuration mode to allow the user to select among, e.g., various PXE boot options that are available to the system, or among various RPL boot options that are available to the system, or among various iSCSI options that are available to the system.

Following 56 in FIG. 2A, a determination is made at 70 to determine whether the user has selected a boot option that requires the option ROM to change from a BCV device to a BEV device or vice versa. If a positive determination is made at 70, then as indicated at 72 either (a) the BCV pointer is changed from a null value to a non-null value that is suitable for the boot option selected by the user (e.g., an iSCSI boot) and the BEV pointer is changed from a non-null value to a null value; or (b) the BEV pointer is changed from a null value to a non-null value that is suitable for the boot option selected by the user (e.g., a PXE boot or an RPL boot) and the BCV pointer is changed from a non-null value to a null value. A suitable operation to write to the flash memory which constitutes the option ROM may be performed to implement the changing of the BCV and BEV pointers, if necessary. Thus the system may select one of the BCV pointer and the BEV pointer to be non-null in response to input received from the user.

Following 72 is a determination made at 74 as to whether the BCV pointer has been initialized (i.e., is currently non-null). If so, the BCV entry point is called (as indicated at 76) and int 13h hooks are installed for any iSCSI disks available to the system. Next it is determined, at 78 (FIG. 2B), whether the system had previously been configured to boot from an iSCSI disk. (Such a configuration may result from the user input described above with respect to FIGS. 3 and 4, or by another configuration process provided as part of the boot process or during manufacturing or assembly or subsequent modification of the system.) If a positive determination is made at 78, i.e., if the system has been configured to boot from an iSCSI disk, booting from the remote disk proceeds, as indicated at 80. If a negative determination is made at 78, i.e., if the system has not been configured to boot from an iSCSI disk, then the system boots from a local disk (e.g., a local hard disk or floppy disk), as indicated at 82.

Considering again the determination made at 74 (FIG. 2A), if a negative determination is made at that point, i.e., if it is determined that the BCV pointer has not been initialized, then a determination is made, as indicated at 84 (FIG. 2B) as to whether the system had previously been configured to boot from a BEV device. (Such a configuration may result from the user input described above with respect to FIGS. 3 and 4, or by another configuration process provided as part of the boot process or during manufacturing or assembly or subsequent modification of the system.) If a positive determination is made at 84, i.e., if the system has been configured to boot from a BEV device, the BEV entry point is called and the system boots accordingly, as indicated at 86. If a negative determination is made at 84, i.e., if the system has not been configured to boot from a BEV device, then the system boots from a local disk, as indicated at 82.

Considering again the determination made at 54 (FIG. 2A), if a negative determination is made at that point, i.e., if it is determined that the user did not press the prescribed key or key combination in response to the screen display of FIG. 3, then the functions described in connection with 56, 70 and 72 are not performed and the screen display shown in FIG. 4 is not displayed to the user. Instead the process proceeds directly from 54 to the functions at 74, 76, etc., or 74, 84 (FIG. 2B), etc., as the case may be.

With switching of BCV and BEV pointers to or from null values as required by user input selection of boot options, the boot image in a single option ROM can support both BCV and BEV device types, notwithstanding the BBS requirement that a device may be either BCV or BEV but not both. The user prompting and boot selection process described herein may be more user-friendly than requiring the user to “re-flash” the device, and may result in less of a user-support burden on the seller or manufacturer of the computer system.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

1. A method comprising:
receiving input from a user; and
in response to the input, selecting one of a BCV (boot connection vector) pointer and a BEV (bootstrap entry vector) pointer to have a non-null value.

2. The method of claim 1, further comprising:
prior to receiving the input, prompting the user to select a boot option from among a plurality of boot options.

3. The method of claim 2, wherein the prompting includes:
displaying the plurality of boot options to the user.

4. The method of claim 3, wherein the input is received in response to the prompting.

5. The method of claim 4, wherein the plurality of boot options includes:
at least one PXE (Pre-boot Execution Environment) option;
at least one RPL (Remote Program Load) option; and
at least one iSCSI (Internet Small Computer System Interface) option.

6. The method of claim 1, wherein the selecting includes changing the BCV pointer from a null value to a non-null value and changing the BEV pointer from a non-null value to a null value.

7. The method of claim 1, wherein the selecting includes changing the BEV pointer from a null value to a non-null value and changing the BCV pointer from a non-null value to a null value.

8. A system comprising:
a processor; and
a memory coupled to the processor and storing a program, the processor operative with the program to:
receive input from a user; and
in response to the input, select one of a BCV (boot connection vector) pointer and a BEV (bootstrap entry vector) pointer to have a non-null value.

9. The system of claim 8, wherein the processor is further operative with the program to:
prior to receiving the input, prompt the user to select a boot option from among a plurality of boot options.

10. The system of claim 9, further comprising:
a display device coupled to the processor;
and wherein the processor is further operative with the program to cause the display device to display the plurality of boot options to the user.

11. The system of claim 10, wherein the input is received in response to the processor prompting the user to select a boot option.

12. The system of claim 11, wherein the plurality of boot options includes:
at least one PXE (Pre-boot Execution Environment) option;
at least one RPL (Remote Program Load) option; and
at least one iSCSI (Internet Small Computer System Interface) option.

13. The system of claim 8, wherein the selecting includes changing the BCV pointer from a null value to a non-null value and changing the BEV pointer from a non-null value to a null value.

14. The system of claim 8, wherein the selecting includes changing the BEV pointer from a null value to a non-null value and changing the BCV pointer from a non-null value to a null value.

15. An apparatus comprising:
a storage medium having stored thereon instructions that when executed by a machine result in the following:
receiving input from a user; and
in response to the input, selecting one of a BCV (boot connection vector) pointer and a BEV (bootstrap entry vector) pointer to have a non-null value.

16. The apparatus of claim 15, wherein said instructions, when executed by said machine, further result in:
prior to receiving the input, prompting the user to select a boot option from among a plurality of boot options.

17. The apparatus of claim 16, wherein the prompting includes:
displaying the plurality of boot options to the user.

18. The apparatus of claim 17, wherein the input is received in response to the prompting.

19. The apparatus of claim 18, wherein the plurality of boot options includes:
at least one PXE (Pre-boot Execution Environment) option;
at least one RPL (Remote Program Load) option; and
at least one iSCSI (Internet Small Computer System Interface) option.

20. The apparatus of claim 15, wherein the selecting includes changing the BCV pointer from a null value to a non-null value and changing the BEV pointer from a non-null value to a null value.

21. The apparatus of claim 15, wherein the selecting includes changing the BCV pointer from a null value to a non-null value and changing the BEV pointer from a non-null value to a null value.
